(19) United States
(12) Patent Application Publication
(10) Pub. No.: US 2007/0230965 A1
(43) Pub. Date: Oct. 4, 2007

(54) Optical Communication Module

(75) Inventor: Tomoharu Horio, Kyoto (JP)

Correspondence Address: HAMRE, SCHUMANN, MUELLER & LARSON, P.C., P.O. BOX 2902, MINNEAPOLIS, MN, 55402-0902, US

(73) Assignee: Rohm Co., Ltd, Kyoto (JP)

(21) Appl. No.: 11/597,841

(22) PCT Filed: Jun. 2, 2005
(86) PCT No.: PCT/JP05/10165

§ 371 Date: Nov. 28, 2006

(30) Foreign Application Priority Data
Jun. 3, 2004 (JP) 2004-165756

(51) Int. Cl. H04B 10/00

(52) U.S. Cl. 398/117

(57) ABSTRACT

An optical communication module (A) of the present invention includes a substrate (1) having an elongated rectangular shape, a light emitting element (2) and a light receiving element (3) mounted on the substrate (1) to be arranged side by side in the longitudinal direction of the substrate, a resin package (5) which includes two lens portions (51, 52) respectively projecting in front of the light emitting element (2) and the light receiving element (3) and covers the light emitting element (2) and the light receiving element (3), and a shield case (6) for shielding the light emitting element (2) and the light receiving element (3) from electromagnetic waves and light. The optical communication module includes a surface extending in the longitudinal direction and serving as a mount surface for mounting on a mounting board (B). Each of the lens portions (51, 52) is covered by the shield case (6) in three directions, two of which correspond to the longitudinal direction of the substrate (1) and one of which is opposite from the direction in which the mount surface is oriented.

### TECHNICAL FIELD

The present invention relates to an optical communication module.

### BACKGROUND ART

Optical communication modules provided with a light emitting-element and a light receiving element for interactive communication include an infrared data communication module conforming to the IrDA (Infrared Data Association) Infrared data communication modules have been widely used in the field of a notebook computer, and recently, also used for a mobile phone and an electronic personal organizer, for example.

An infrared data communication module includes an infrared emitting element, an infrared receiving element and a control circuit element for controlling these, which are contained in one package. Such an infrared data communication module can perform wireless interactive communication with other infrared data communication modules.

FIG. 7 shows an example of conventional infrared data communication module. The infrared data communication module X includes a substrate 91, and a light emitting element 92, a light receiving element 93 and a drive IC 94 which are mounted on the substrate 91. The infrared data communication module X further includes a resin package 95 which covers the light emitting element 92, the light receiving element 93, and the drive IC 94. The resin package 95 includes lens portions 95aand 95b positioned in front of the light emitting element 92 and the light receiving element 93, respectively.

The light emitting element 92 converts an electric signal from the drive IC 94 into an optical signal and emits infrared as the optical signal. The emitted infrared travels to the outside through the lens portion 95a and is received by the light receiving element of another infrared data communication module (not shown). Infrared emitted from another infrared data communication module is received by the light receiving element 93 through the lens 95b. The light receiving element 93 converts the received infrared into an electric signal and outputs to the drive IC 94. By these operations, the infrared data communication module X can perform interactive communication with other infrared data communication modules.

Almost entirety of the substrate 91 and the resin package 95 are covered by a shield case 96 attached thereto. When the drive IC 94 receives electromagnetic noise or visible light, the drive IC malfunctions, and the shield case is provided to prevent such a problem. The shield case 96 is formed by bending a metal plate. The shield case 96 includes a main plate portion 96a covering side surfaces of the resin package 95 and the substrate 91, two first bent portion 96b covering opposite end surfaces of the resin package 95 and the substrate 91, a second bent portion 96c covering a region between the two lens portions 95a and 95b, and a third bent portion 96d extending from the edge of the second bent portion.

When the shield case 96 is mounted to the substrate 91 and the resin package 95, the upper side and lateral sides of each of the lens portions 95a and 95b are covered by part of the main plate portion 96a and part of the first bent portion 96b. Specifically, the upper side of the lens portion 95a is covered by a front end 96A of the main plate portion 96a. The right side of the lens portion 95a is covered by a front end 96B of one of the first bent portion 96b. On the other hand, the upper side of the lens portion 95b is covered by a front end 96A of the main plate portion 96a. The left side of the lens portion 95b is covered by a front end 96B of the other first bent portion 96b.

Therefore, of the infrared rays emitted from the light emitting element 92, the infrared ray emitted at an unduly wide angle toward the portions covered by the front end 96A of the main plate portion 96a and the front end 96B of the first bent portion 96b is blocked by the shield case 96. Similarly, the infrared ray traveling toward the lens 95b from the direction in which the front end 96A′ of the main plate portion 96a and the front end 96B′ of the first bent portion 96b are arranged is blocked by the shield case 96. Therefore, this infrared is prevented from being received by the light receiving element 93 through the lens portion 95b. In this instance, the front ends 96A, 96A′ of the main plate portion 96a and the front ends 96B, 96B′ of the first bent portions 96b serve as a light shielding portion for blocking infrared rays.

Therefore, when the infrared data communication module X performs interactive communication with another infrared data communication module, erroneous infrared emission to a device other than the communication target device can be prevented. Further, the infrared data communication module X is prevented from receiving infrared from a device other than the communication target device.

However, according to the infrared data communication module X, a light shielding portion for blocking light traveling in the direction in which the lens portions 95a and 95b face each other is not provided between the lens portions. Therefore, part of the infrared emitted from the light emitting element 92 may unduly travel toward the lens portion 95b through the lens portion 95a. Further, the infrared traveling toward the lens portion 95b from a direction deviated toward the lens portion 95a may be unduly received by the light receiving element 93.

Therefore, in the infrared data communication module X, the communication of the infrared data communication module X may be sometimes hindered, and there is a room for improvement with respect to the light shielding by the shield case 96.

Patent Document 1: JP-A-2003-8066

### DISCLOSURE OF THE INVENTION

The present invention is conceived under the above-described circumstances. It is, therefore, an object of the present invention to provide an optical communication module which is capable of directing the light emitted from the light emitting element to a proper region and capable of receiving light traveling from a proper region by the light receiving element.

According to the present invention, there is provided an optical communication module comprising a substrate having an elongated rectangular shape, a light emitting element and a light receiving element mounted on the substrate to be arranged side by side in a longitudinal direction of the substrate, a resin package which includes two lens portions respectively projecting in front of the light emitting element and the light receiving element and covers the light emitting element and the light receiving element, and a shield case for shielding the light emitting element and the light receiving element from electromagnetic waves and light. The optical communication module includes a surface extending in the longitudinal direction and serving as a mount surface for mounting on an external mount target member. Each of the lens portions is covered by the shield case in three directions, two of which correspond to the longitudinal direction of the substrate and one of which is opposite from the direction in which the mount surface is oriented.

Preferably, the shield case is formed by bending a metal plate and includes a main plate portion covering a side surface of the resin package which is on an opposite side of the mount surface, two first bent portions covering opposite end surfaces of the resin package, a second bent portion covering a region between the two lens portions of the resin package, a third bent portion extending from an end of the second bent portion in a direction along the mount surface, and two fourth bent portions extending from opposite ends of the third bent portion in the width direction of the substrate. Each of the lens portions is covered in the above-described three directions by the main plate portion, the first bent portion and the fourth bent portion.

Preferably, the shield case further includes a fifth bent portion covering a reverse surface of the substrate.

Preferably, the resin package is formed with a recess between the two lens portions, and the second bent portion of the shield case is formed with a projection for fitting into the recess.

Preferably, the shield case is connected to ground by utilizing the third bent portion.

### BRIEF DESCRIPTION OF THE DRAWINGS

FIG. 1 is an overall perspective view showing an example of optical communication module according to the present invention.

FIG. 2 is a sectional view taken along lines II-II in FIG. 1.

FIG. 3 is a sectional view taken along lines III-III in FIG. 1.

FIG. 4 is an exploded perspective view showing the optical communication module according to the present invention.

FIG. 5 shows a metal plate for forming a shield case used in the optical communication module of the present invention.

FIG. 6 is a perspective view showing a principal portion of another example of optical communication module according to the present invention.

FIG. 7 is an exploded perspective view showing an example of conventional optical communication module.

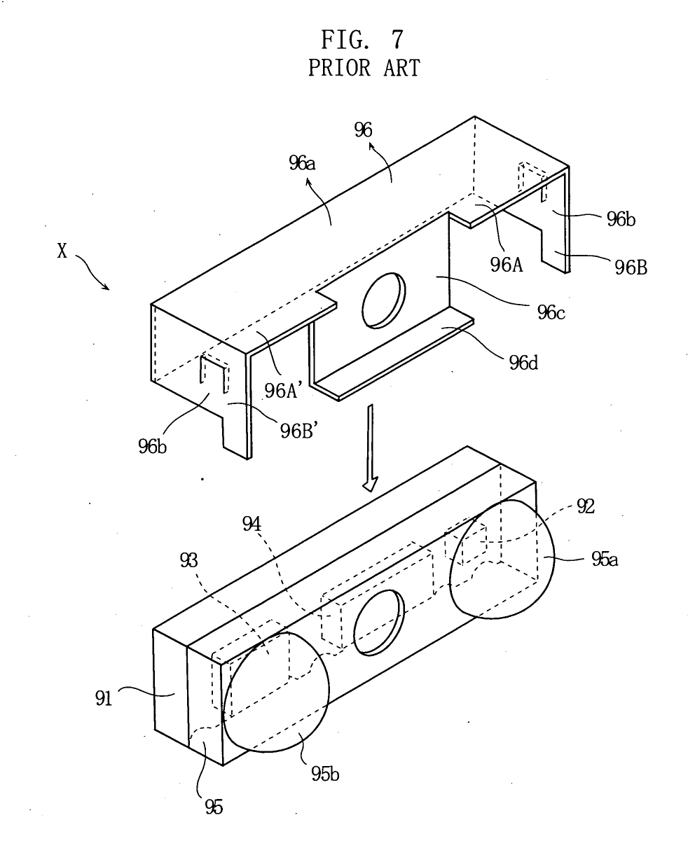

### BEST MODE FOR CARRYING OUT THE INVENTION

Preferred embodiments of the present invention will be described below in detail with reference to the accompanying drawings.

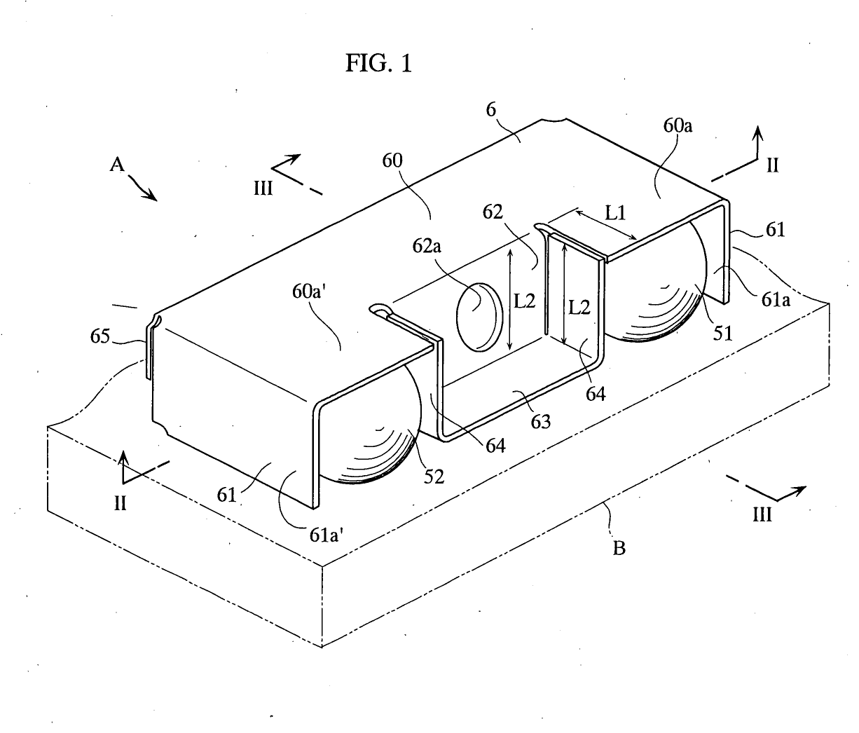

FIGS. 1-4 show an example of optical communication module according to the present invention. The infrared data communication module A includes a substrate 1, a light emitting element 2, a light receiving element 3 and a drive IC 4 which are mounted on an obverse surface 1a of the substrate 1, a resin package 5 covering these parts, and a shield case 6.

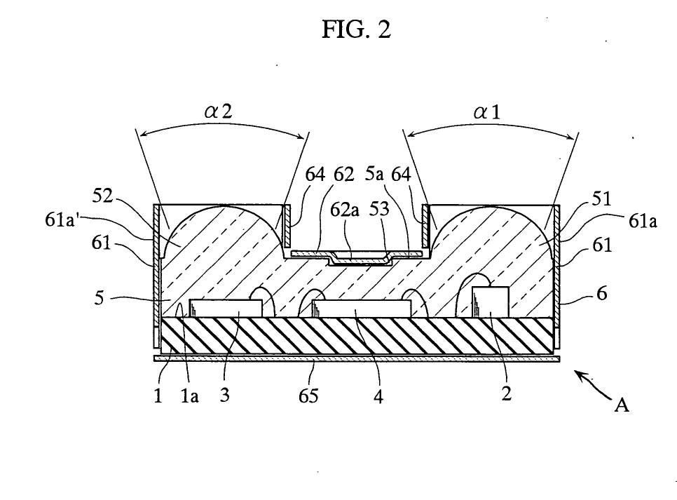

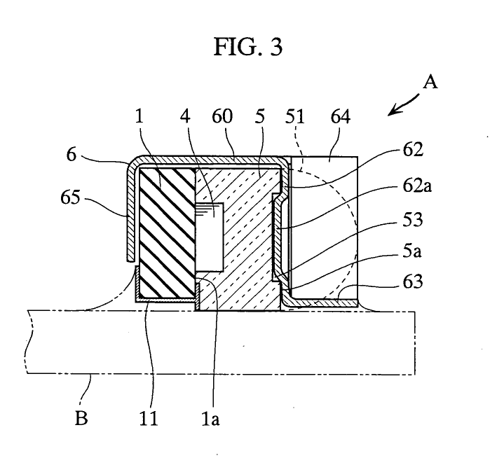

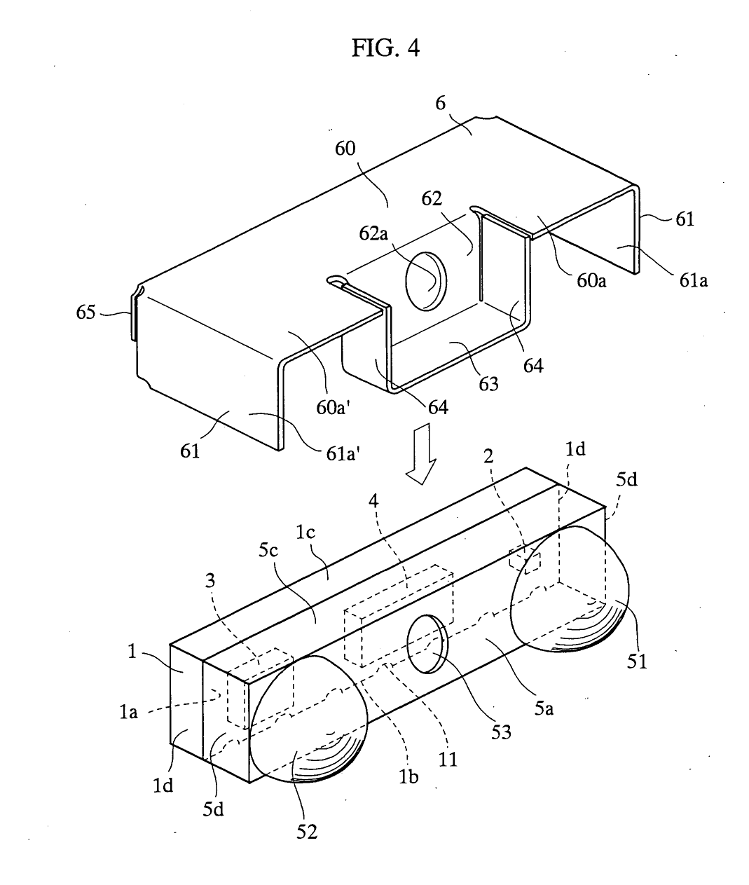

The substrate 1 is in the form of an elongated rectangle in plan view and made of a resin such as glass-fiber-reinforced epoxy resin. The obverse surface 1a (See FIG. 2) of the substrate 1 is formed with a predetermined wiring pattern (not shown) The substrate 1 has a side surface lb (See FIG. 4) formed with a plurality of connection terminals 11. Each of the connection terminals 11 comprises a conductive layer formed on the inner surface of a groove extending in the thickness direction of the substrate 1. The infrared data communication module A is mounted on a mounting board B as shown in FIG. 3 by utilizing the connection terminals 11.

The light emitting element 2 comprises e.g. an infrared emitting diode for emitting infrared and is connected to the wiring pattern by wire bonding. The light receiving element 3 comprises e.g. a PIN photodiode capable of detecting infrared and is connected to the wiring pattern by wire bonding. The drive IC 4 controls the transmitting and receiving operations of the light emitting element 2 and the light receiving element 3. The drive IC 4 is connected to the wiring pattern by wire bonding and connected to the light emitting element 2 and the light receiving element 3 via the wiring pattern. In the infrared data communication module A, the drive IC 4 is prevented from being influenced by visible light.

For instance, the resin package 5 is made of epoxy resin containing a pigment. The resin package 5 is not pervious to visible light, but pervious to infrared. The resin package 5 may be formed by transfer molding, for example.

The resin package 5 is integrally formed with a light emitting lens portion 51 positioned infront of the light emitting element 2. The light emitting lens portion 51 is designed to collect infrared emitted from the upper surface of the light emitting element 2 and guides the infrared to the outside. Further, the resin package 5 is integrally formed with a light receiving lens portion 52 positioned in front of the light receiving element 3. The light receiving lens portion 52 is designed to collect infrared transmitted to the infrared data communication module A and causes the infrared to impinge on the light receiving element 3.

The shield case 6 is used for electromagnetic shielding and light shielding and provided to cover the substrate 1 and the resin package 5. The shield case 6 is formed by bending a metal plate and includes a main plate portion 60 and a first through a fifth bent portions 61-65.

The main plate portion 60 is generally channel shaped and covers the side surfaces lc and 5c of the substrate 1 and the resin package 5, which are on the opposite side of the connection terminals 11. Two first bent portions 61 extend downward from opposite ends of the main plate portion 60 and cover the opposite end surfaces ld and 5d of the substrate 1 and the resin package 5. The front ends 60a, 60a ′ of the main plate portion 60 and front ends 61b, 61b ′ of the two first bent portions 61 serve as a light shielding portion for covering two sides of each of the lens portions 51 and 52.

Specifically, when the shield case 6 is mounted to the substrate 1 and the resin package 5, the upper side of the lens portion 51 is covered by the front end 60a of the main plate portion 60, whereas the right side of the lens portion 51 is covered by the front end 61a of one of the first bent portions 61. On the other hand, the upper side of the lens portion 52 is covered by the front end 60a ′ of the main plate portion 60, whereas the left side of the lens portion 52 is covered by the front end 61a ′ of the other first bent portion 61.

The second bent portion 62 extends downward from the bottom edge of a recess of the main plate portion 60. The second bent portion 62 is formed with an embossed portion 62a. The resin package 5 is formed, at the surface 5a between the two lens portions 51 and 52, with a recess 53 for receiving the embossed portion 62a. When the shield case 6 is mounted to the resin package 5, the embossed portion 62a is fitted into the recess 53. Therefore, the shield case 6 can be reliably fixed to the resin package 5 without using e.g. an adhesive.

The third bent portion 63 extends from an end of the second bent portion 62 in a direction along the mounting board B. As shown in FIG. 3, the lower surface of the third bent portion 63 is soldered to the wiring pattern (not shown) of the mounting board B so that the shield case 6 is connected to a ground terminal on the wiring pattern.

The two fourth bent portions 64 extend upward from opposite ends of the third bent portion 63, and the respective ends of the two fourth bent portions are positioned close to the main plate portion 60. As shown in FIGS. 1 and 2, the fourth bent portions 64 are located between the lens portions 51 and 52 to cover the lens portions and serve as a light shielding portion. In this way, in the infrared data communication module A, each of the lens portions 51 and 52 is shielded from light on three sides by the front ends 60a, 60a ′ of the main plate portion 60, the front ends 61b, 61b ′ of the two first bent portions 61, and the two fourth bent portions 64.

The fifth bent portion 65 extends downward from the main plate portion 60 and covers part of the reverse surface 1d of the substrate 1.

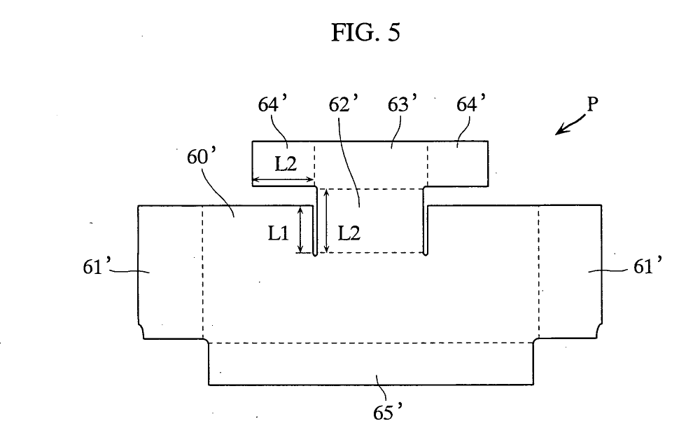

For instance, the shield case 6 may be formed by preparing a metal plate P as shown in FIG. 5 and successively performing bending for each portion. The metal plate P includes bend target portions 60′-65′ which are to become the main plate portion 60 and the first through the fifth bent portions 61-65, respectively.

As shown in FIG. 1, to make the shield case 6 from a single metal plate P, it is preferable that the dimension L1 of the region of the main plate portion 60 which covers the lens portions 51, 52 is smaller than the dimension L2 of the second and the fourth bent portions 62. As shown in FIG. 5, when the dimension L1 is smaller than the dimension L2, the bend target portion 60 and the two bend target portions 64′ are prevented from coming into contact with each other, which is preferable for making the shield case 6 from the metal plate P.

The operation and advantages of the infrared data communication module A will be described below.

As shown in FIG. 2, with respect to the longitudinal direction of the substrate 1, the lens portions 51 and 52 are shielded from light by the front ends 61b and 61b ′ of the first bent portions 61, and the fourth bent portions 64. In this embodiment, the edges of the front ends 61b, 61b ′ of the first bend portions 61 and the fourth bent portions 64 are generally flush with the top of the lens portions 51, 52. The front ends 61b, 61b ′ of the first bend portions 61 and the fourth bent portions 64 serve as a light shielding portion and block infrared emitted from the lens portion 51 at an unduly wide angle and infrared traveling toward the lens portion 52 from an unduly wide angle.

The light emission angle al of the infrared to be emitted from the lens portion 51 and the light receiving angle α2 of the infrared to be received by the lens portion 52 can be adjusted appropriately. For instance, according to the IrDA standard, the data communication angle for interactive data communication between infrared data communication modules is defined as 30 degrees. In the infrared data communication module A, the light emission angle α1 and the light receiving angle α2 can be easily adjusted by changing the length of the first bent portions 61 and the fourth bent portions 64 in the depth direction. Therefore, the infrared data communication module A can easily meet with the above-described standard by appropriately setting the light emission angle α1 and the light receiving angle α2.

The shielding of lens portions 51 and 52 from the light traveling in the width direction of the substrate 1 is properly performed by the main plate portion 60 and the mounting board B. The light emission angle and the light receiving angle in the width direction can also be easily adjusted by changing the length of the main plate portion 60 in the depth direction or the mount position of the infrared data communication module A on the mounting board B, for example.

According to this embodiment, the shield case 6 can be formed by successively bending a single metal plate P as shown in FIG. 5. Therefore, the shield case 6 having the light shielding effect as described above can be manufactured without performing any special process step and with the same level of manufacturing efficiency as that of the conventional shield case.

According to this embodiment, the shield case 6 can be fixed properly without using e.g. an adhesive by fitting the embossed portion 62a formed at the second bent portion 62 into the recess 53 of the resin package 5. The embossed portion 62a can be easily formed in bending the metal plate P, for example. Further, by transfer molding the resin package 5 in such a manner that the trace of the ejector pin is formed between the lens portions 51 and 52 shown in FIG. 4, the recess 53 can be easily formed without the need for performing any special process step such as machining.

According to this embodiment, by the provision of the fifth bent portion 65, the shield case 6 can hold the substrate 1 and the resin package 5 by utilizing the second and the fifth bent portions 62 and 65, whereby the shield case 6 is properly fixed. Instead of the embossed portion 62a, the second bent portion 62 may be formed with a V-shaped notch, and this portion may be bent through a small angle to project toward the resin package 5.

The optical communication module according to the present invention is not limited to the foregoing embodiment. The specific structure of each part of the optical communication module according to the present invention may be varied in various ways.

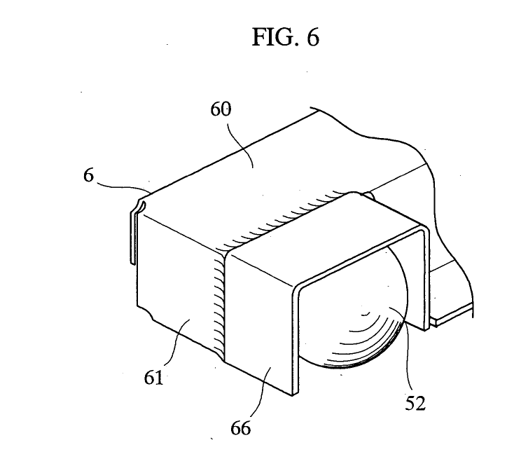

Although it is reasonable that the shield case 6 has a structure including first through fifth bent portions 61-65 so that the shield case is made from a single metal plate P like the foregoing embodiment, the present invention is not limited thereto. For instance, as shown in FIG. 6, a member 66 which is capable of surrounding three sides of the lens portion 51, 52 may be formed by bending a relatively small strip of metal plate into a channel shape, and this member 66 may be bonded to the main plate portion 60 and the first bent portion 61 to complete the shield case 6.

The light emitting element 2 and the light receiving element 3 are not limited to those capable of emitting and receiving infrared, and use may be made of those capable of emitting and receiving visible light. Therefore, the optical communication module is not limited to an infrared data communication module and may be designed to perform communication by utilizing visible light.

1. An optical communication module comprising:
an elongated rectangular substrate;
a light emitting element and a light receiving element mounted on the substrate to be arranged side by side in a longitudinal direction of the substrate;
a resin package including two lens portions respectively projecting in front of the light emitting element and the light receiving element, the package covering the light emitting element and the light receiving element;
a shield case for shielding the light emitting element and the light receiving element from electromagnetic waves and light; and
a side surface extending in the longitudinal direction and serving as a mount surface for mounting on an external mount target member;
wherein each of the lens portions is covered by the shield case in three directions, two of which correspond to the longitudinal direction of the substrate and one of which is opposite from the direction in which the mount surface is oriented.

2. The optical communication module according to claim 1, wherein the shield case is formed by bending a metal plate and includes a main plate portion covering a side surface of the resin package which is on an opposite side of the mount surface, two first bent portions covering opposite end surfaces of the resin package, a second bent portion covering a region between the two lens portions of the resin package, a third bent portion extending from an end of the second bent portion in a direction along the mount surface, and two fourth bent portions extending from opposite ends of the third bent portion in a width direction of the substrate; and
wherein each of the lens portions is covered in said three directions by the main plate portion, the first bent portion and the fourth bent portion.

3. The optical communication module according to claim 2, wherein the shield case further includes a fifth bent portion covering a reverse surface of the substrate.

4. The optical communication module according to claim 2, wherein the resin package is formed with a recess between the two lens portions, and the second bent portion of the shield case is formed with a projection for fitting into the recess.

5. The optical communication module according to claim 2, wherein the shield case is connected to ground by utilizing the third bent portion.
